(19) United States
(12) Patent Application Publication
(10) Pub. No.: US 2006/0009068 A1
(43) Pub. Date: Jan. 12, 2006

(54) Cable labeling caps

(76) Inventors: Michael Greene, Sherman Oaks, CA (US); Kirk Langman, Beverly Hills, CA (US)

Correspondence Address: MICHAEL GREENE, 15344 WEDDINGTON ST., # 217, SHERMAN OAKS, CA, 91411, US

(21) Appl. No.: 10/884,509

(22) Filed: Jul. 6, 2004

(51) Int. Cl. H01R 3/00

(52) U.S. Cl. 439/488

(57) ABSTRACT

Cable Label with a connector portion and a tag portion The tag portion is fixedly attached to the connector portion by a flexible tab. The connector portion can be of two types, one shaped to frictionally receive the end of a standard female phone jack and the second shaped to receive the end of a standard male jack. The tag portion is comprised of a flat elongate plate that includes a flat surface to receive writing or attachment of a paper label that can be written on. A preferred embodiment includes a plurality of non printed or pre-printed paper labels that can be attached to the flat surface of the tag portion. A preferred embodiment includes the paper labels having pre-printed numbers or letters or the like.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of identifying labels and more specifically to a cable Labeling caps.

Many people own audio and video systems that include a plurality of separate components that are connected to each other by means of audio or video cables. These cables are typically plugged into the rear portion of each component. When a person owning such equipment decides to relocate, add or supstitute the equipment, for example to another home or apartment, the person usually must detach the cable connectors from their respective audio or video components and then reattach them when the components are installed in their new location. Unfortunately, this can be a confusing, frustrating and time consuming task.

Attempts have been made to market labels for cables and the like. They usually consist of a tag and a standard tie wrap strip attached to one end of the tag. The user can write what component the cable goes to on the flat surface of the tag.

Unfortunately, there are deficiencies in the current cable labeling technology. First, although the cable is labeled, there is no mating label available for attachment to the audio or video component itself. Second, because there is no provision for labeling the audio or video component, the user must devote extra time and attention to write, on the tag, which component the cable goes to. Finally, Labels that use standard tie wrap mechanisms can slip up or down the cable making them time consuming to install and to remove.

### BRIEF SUMMARY OF THE INVENTION

The primary object of the invention is to provide a labeling system for audio and video cables as well as related audio or video hardware.

Another object of the invention is to provide a labeling system that allow the user to detach a plurality of cables from their respective audio or video components and to quickly label each cable and component so that the user can easily and accurately reconnect the cables to their respective components at a future time.

Another object of the invention is to provide a labeling system that allows the user to use either color or written description when creating an identification for a cable or component.

A further object of the invention is to provide a labeling system that can be reused.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a cable label system comprising: a connector portion, a tag portion, said tag portion fixedly attached to said connector portion by a flexible tab, said connector portion being of two types, one shaped to frictionally receive the end of a standard female phone jack and the second being shaped to frictionally receive the end of a standard male phone jack, and said tag portion being comprised of a flat elongate plate that includes a flat surface to receive writing or the attachment of a paper label that can be written on.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention designed to be removably attached to a standard female phone jack connector.

FIG. 2 is a perspective view of the invention designed to be removably attached to a standard male phone jack connector.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

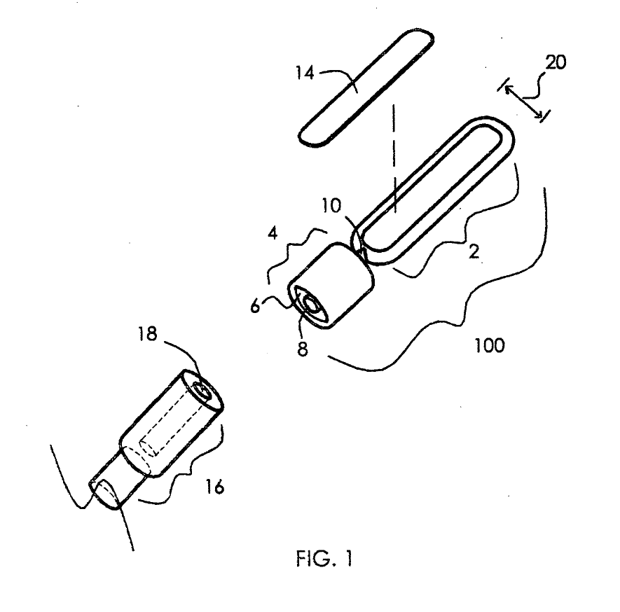

Referring now to FIG. 1 we see a perspective view of the version of the invention 100 that accepts a standard female phone jack connector 16. This label device 100 can frictionally fit over a standard female phone jack connector that can be found on one end of a audio or video cable 16, or as can be found as the input and output jacks on the rear of standard audio and video equipment as shown in FIG. 3. Referring back to FIG. 1 we see that the invention 100 is comprised of a barrel shaped 4 portion having a hollow interior 6 and a centrally located post 8. The interior diameter 6 and post diameter 8 are dimensioned so that the post 8 can be frictionally inserted into aperture 18 and the outside diameter of cable connector 18 can be frictionally fitted into the inside diameter of barrel interior 6. A tab portion 10 connects the barrel portion 6 to the tag portion 2. The tag portion 2 is a flat panel and includes a recess 12 so that a paper label 14 can be affixed neatly onto tag portion 12. The user may choose to write directly on the recessed portion 12, or to write on paper label 14 which is then affixed to portion 12. The paper labels 14 can be offered in white, or in a variety of colors, or can be pre-printed with numbers or letters or component names. The width of tag 2 as shown by dimension line 20 is approximately three hundred thousandths of an inch so that a plurality of cable labels 100 can be plugged into a row of closely spaced phone jack connectors that are commonly found at the rear of standard audio and video equipment. The user may identify the corresponding cable to a mating audio or video component by simple color coding. For example, by attaching a red colored cable label to the output jack of a standard audio component, and by attaching a red colored cable label to the mating cable end, the user knows that this particular cable attaches to this particular output jack. The frictional attachment means of the inner post 8 as well as the inner diameter 6 assures that the cable label 100 will remain with the audio component until the user physically removes it. A set of ten cable labels 100 could be offered in different colors so that the user would not have to go to the trouble of actually printing the name of the audio component on the tag portion 2. The tag portion 2 is also ideally suited to act as a pull tab to help remove the cable label 100 when necessary. The tab portion 10 is resilient and thereby allowing the tag portion 2 to flex out of the way when a person is in the process of removing or inserting a cable label 100 onto closely spaced phone jacks located on the rear of an audio or video component.

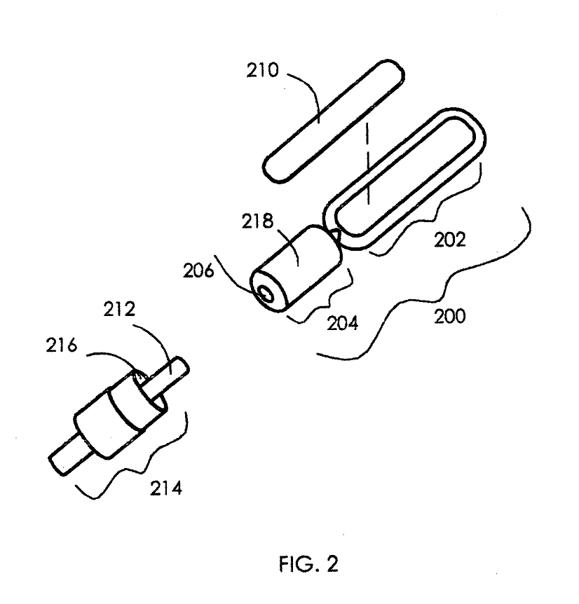

A second embodiment of the invention 200 is shown in FIG. 2. In this case, the barrel portion 204 includes an aperture 206 that can frictionally engage the post portion 212 of a standard male end of an audio or video cable. The outside diameter 218 of barrel portion 204 frictionally fits into the inside diameter 216 of cable connector 214. Tag 202, tab 208 and paper label 210 are all identical to items found in the version 100 of the invention.

As shown by the above descriptions and illustrations, the present invention can be a great help to a person who is disassembling his or her audio or video component system and wishes to quickly and easily create identification means for each output or input jack of each component as well as each cable tip so that he or she can easily reinstall the cables and components during the reassembly activity.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Cable Label comprising:
a connector portion;
a tag portion;
said tag portion fixedly attached to said connector portion by a flexible tab;
said connector portion being of two types, one shaped to frictionally receive the end of a standard female phone jack and the second being shaped to receive the end of a standard male jack; and
said tag portion being comprised of a flat elongate plate that includes a flat surface to receive writing or attachment of a paper label that can be written on.

2. Cable Label as claimed in claim 1 wherein said cable label is injection molded from a resilient plastic such as polypropylene or the like.

3. Cable Label as claimed in claim 1 wherein said cable label is molded in a variety of colors so that the label my provide an identifying means by color alone without the need for additional indices.

4. Cable Label as claimed in claim 1 further comprising a plurality of non printed or pre-printed paper labels that can be attached to said flat surface of said tag portion.

5. Cable Label as claimed in claim 4 wherein said paper labels can include pre-printed numbers or letters or the like.

6. Cable Label as claimed in claim 1 wherein one version of said cable label connector portion is sized to receive either the male portion of female portion of a standard BNC video cable connector.

7. Cable Label as claimed in claim 1 wherein said connector portion can be sized for future cable connectors that have yet to be designed.
